(19) United States
(12) Patent Application Publication
(10) Pub. No.: US 2003/0030261 A1
(43) Pub. Date: Feb. 13, 2003

(54) Inflatable airbag

(76) Inventors: Laurent Perrier, Mauquenchy (FR); Olivier Pineau, Ermont (FR)

Correspondence Address: JACOBSON HOLMAN PLLC, 400 SEVENTH STREET N.W., SUITE 600, WASHINGTON, DC, 20004, US

(21) Appl. No.: 10/046,992

(22) Filed: Jan. 15, 2002

(30) Foreign Application Priority Data
Aug. 9, 2001 (DE) 201 13 191.9

(51) Int. Cl. H04M 3/00; B60R 21/16

(52) U.S. Cl. 280/743.1; 455/419; 455/422; 455/418

(57) ABSTRACT

An inflatable airbag (1) for the protection of a vehicle occupant, consisting of a front layer (2) and a rear layer (3) of flexible, tear-resistant material which are connected and folded and/or rolled together along a common peripheral edge (4). The rear layer (3) faces away from the vehicle occupant and is connected to an inflator (5) by a central opening. The halves or parts of the flat-lying bag disposed on both sides of a line of symmetry (9) are folded by at least two inside folds (11, 12; 15, 16) which are disposed between the layers (2, 3) and whose fold edges (13, 14) extend beyond the line of symmetry (9) and which enclose a connection fold between them. The connection fold having an outwardly directed seam (6) or an outwardly directed seam (4), and the halves disposed on the line of symmetry (9) are folded or rolled in the direction of the bag center.

The invention relates to an inflatable airbag for the protection of a vehicle occupant comprising a front layer and a rear layer of flexible, tear-resistant material which are connected and folded and/or rolled together along their common peripheral edge, with the rear layer facing away from the vehicle occupant being connected to an inflator by a central opening.

A particular problem of such airbags consists of their being inflated in an almost explosion-like manner in case of danger after ignition of the inflator so that the inflated airbag can hit the vehicle occupant to be protected with a hard impact. The unfolding of the airbag on inflation and the kind of contact with the vehicle occupant during inflation is greatly influenced by the kind of folding and/or rolling of the empty bag into its inactive stand-by position.

Airbags are known from U.S. Pat. Nos. 5,425,551 and 5,538,281 whose halves lying at a central line of symmetry are rolled or folded symmetrically. However, such symmetrical folds and rolls make it possible for the bag to reach the inflated position abruptly after the ignition of the inflator so that they hit the vehicle occupant abruptly.

An airbag is known from DE 197 36 243 A1 whose sides are respectively folded in a zig-zag manner such that the fold of one wall encloses the fold of the other wall between it and the folds lie on top of one another in a stack.

It is the object of the invention to provide a fold and/or roll for an inflatable air bag of the kind first mentioned which, on the one hand, ensures a fast inflation for the protection of the vehicle occupant after the ignition of the inflator and, on the other hand, supports the vehicle occupant gently and safely without a hard impact.

In accordance with the invention, this object is solved by the features of claim 1.

It has surprisingly been shown that this kind of folding in accordance with the invention results in an inflation of the airbag after the ignition of the inflator that supports the vehicle occupant to be protected quickly and gently.

Due to the folding in accordance with the invention, the inner space of the airbag is in direct communication with the inflator so that the bag can expand quickly at the start after ignition while avoiding too excessive pressures. A further unfolding delays the expansion speed of the front side of the bag with respect to the vehicle occupant to be protected and thereby favours the folding and expansion of the side regions.

Each side part of the bag is appropriately folded only by two inside folds lying on top of one another.

In another aspect of the invention, it is provided that the connection fold connecting the two inside folds is provided with another inner fold. The layers of this further inner fold can be connected to a tear seam region by an adhesive. This tear seam region can be formed by an adhesive seam which can be torn open, which extends at a spacing from the seam connecting the two layers and which bounds the seam region.

In accordance with a particularly preferred embodiment, it is provided that the sides of the bag disposed at both sides of the line of symmetry are folded in overlapping planes such that the sides provided with the inside folds overlap in a manner lying on top of one another. The laying of the inside folds can take place such that first the inside folds of a side of the flat-lying bag is formed, then the other side is raised and the inside folds formed in these in mirror fashion in generally the same manner. Trials have shown that such an asymmetrical folding of the bag halves and the rolling of the halves lying on the line of symmetry results in a particularly favourable inflation behaviour of the bag which supports the vehicle occupant to be protected gently, on the one hand, and fast and safely, on the other.

The folding of the invention, in which two left hand inside folds are overlaid in the base region by two right hand inside folds, ensures that the region of the bag located in the closest proximity to the inflator expands quickly. The side parts also unfold faster, and indeed in the substantially perpendicular direction with respect to the front side of the bag.

If the two layers with mutually connecting seams are enclosed by a tear seam, the bag unfolds completely by tearing open this tear seam region in a second folding stage which is not hindered by laid-in folds.

It is furthermore particularly advantageous to tilt forwards the rolled or folded bag halves disposed in symmetry in the direction of the vehicle occupant to be protected.

The flat-lying bag preferably has a rectangular or square shape.

In accordance with another aspect, the object is solved in that the halves of the flatlying bag disposed on both sides of a line of symmetry are folded in a zig-zag manner towards the common centre.

In accordance with another embodiment, it is provided that the two layers of the bag are put together by a plurality of inside folds directed against one another such that the front layer put together by inside folds lies on the lower layer put together by inside folds.

Embodiments of the invention are described in more detail in the following with reference to the drawing, in which there are shown:

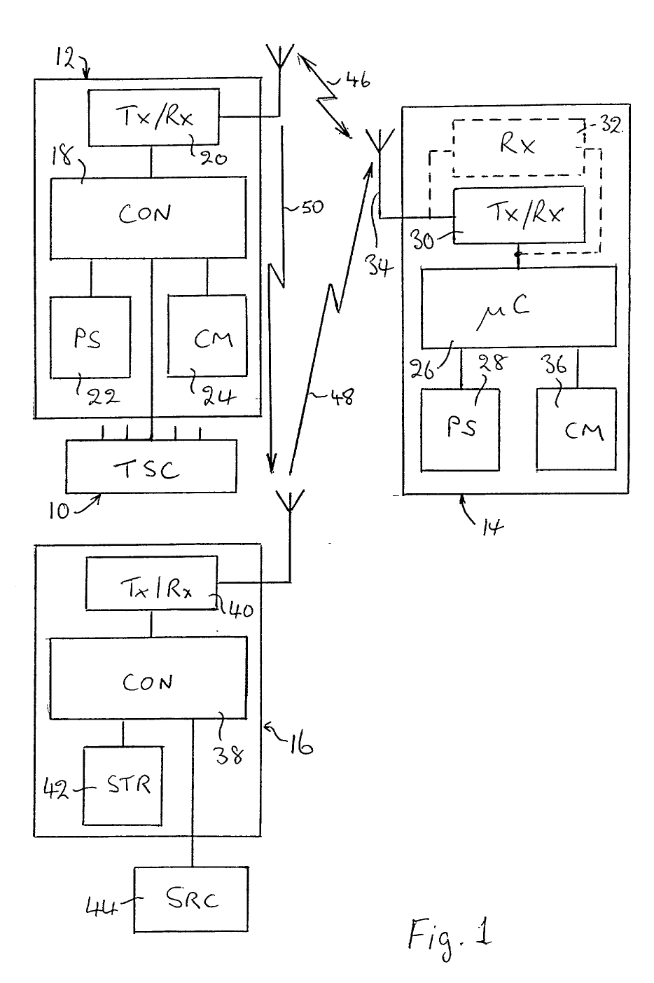

FIG. 1a a plan view of a flat-lying inflatable air bag before its folding or putting into its inactive stand-by position;

FIG. 1b a section through the bag in accordance with FIG. 1a along the line I-I in FIG. 1a;

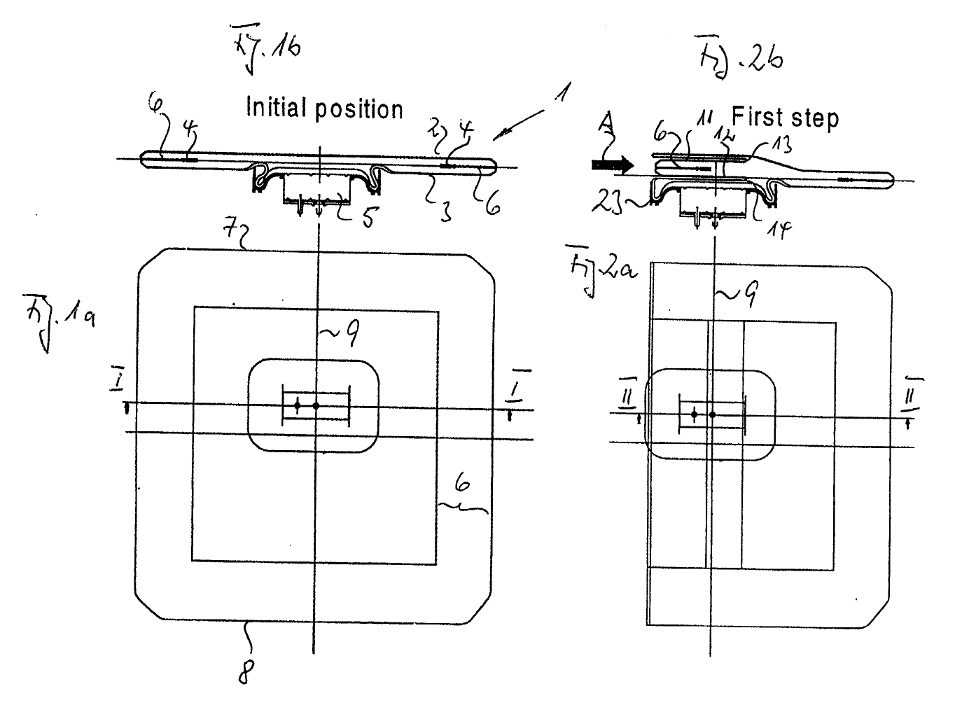

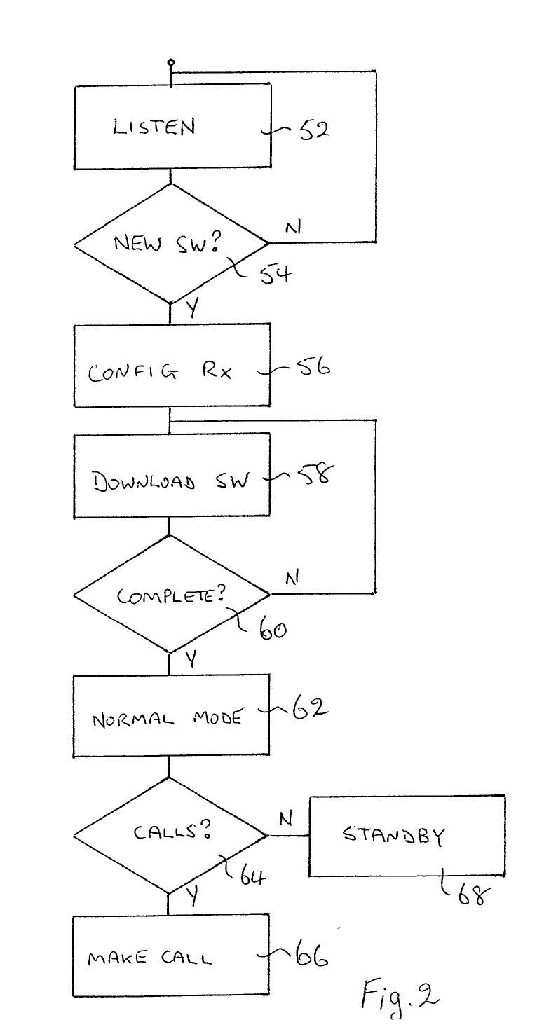

FIG. 2a a plan view of the bag after the folding of the half disposed to the left of the line of symmetry;

FIG. 2b a section through the bag along the line II-II in FIG. 2a;

FIG. 3a a plan view of the bag after the folding of the right hand half in a plane above the left hand half;

FIG. 3b a section through the bag along the line III-III in FIG. 3a;

FIG. 4a a plan view of the bag in accordance with FIG. 3a after the rolling in and tilting forwards of the upper half;

FIG. 4b a section through the bag along the line IV-IV in FIG. 4a;

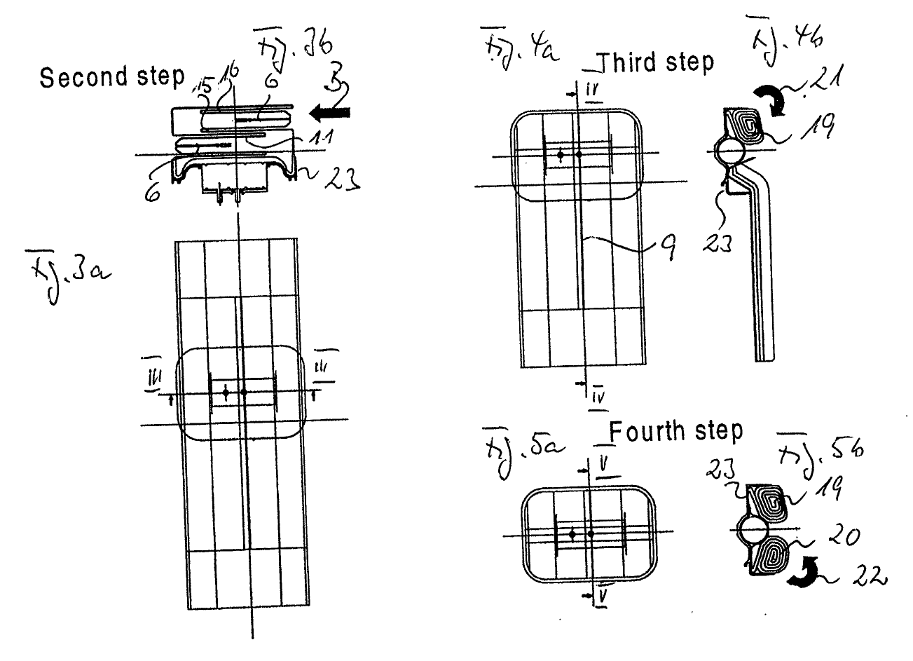

FIG. 5a a plan view of the bag after the rolling in and tilting forwards of both halves disposed on a line of symmetry;

FIG. 5b a section through the bag along the line V-V in FIG. 5a;

FIG. 6 a section through a bag whose right hand half is folded towards the centre in a zig-zag manner;

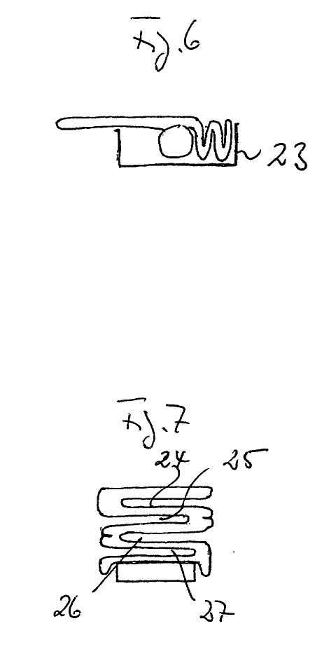

FIG. 7 a section through a bag whose side walls are folded into one another in a zig-zag manner;

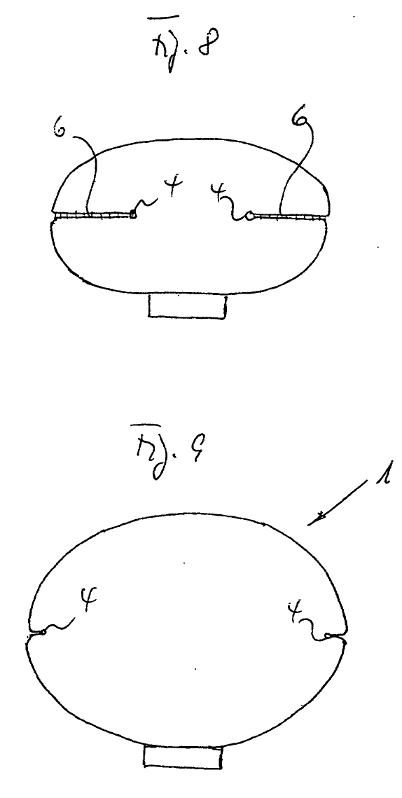

FIG. 8 a section through an airbag in which the tear seam regions have not yet been torn open; and

FIG. 9 a completely inflated airbag.

The flat-lying, inflatable airbag 2 visible from FIGS. 1a and 1b consists of an upper layer 2 and a lower layer 3 which are connected to one another along the common peripheral edge 4. In the embodiment shown, the upper layer 2 and the lower layer 3 are connected to one another while adjoining the seams 4 by tear seam regions 6 which can be formed by a releasable adhesive which, on the one hand, effects the adhesion of the tear seam regions and, on the other hand, allows a tearing open in a second stage during inflation up to the seams 4 and thus a complete inflation of the airbag.

The flat-lying bag has a rectangular or square shape with truncated corners. The lower layer 3 is provided with a central opening whose rims are fixedly connected to the opening of the inflator 5. The flat-lying bag has a left hand and a right hand half which are disposed symmetrically with respect to a line of symmetry 9 extending through the centre of two sides 7, 8 of the bag 1 parallel to one another. The folding of the bag 1 into its inactive stand-by position is now explained by way of the steps visible from FIGS. 2 to 5.

In a first step, the parts of the upper and lower layers disposed above and below the tear seam region 6 of the left hand side are folded by inside folds 11, 12 such that the inside fold edges 13, 14 extend beyond the line of symmetry 9 into the right hand half. After this folding visible from FIGS. 2a and 2b, the left hand tear seam region 6 is disposed between the inside folds 11, 12 with the seam 4, however, not extending beyond the line of symmetry 9 into the right hand part.

In a second step, the right hand half is now raised over the left hand half and the inside folds 15, 16, which enclose the tear seam region 6 of the right hand side, are formed in a corresponding manner, with the inside fold 15 lying on the inside fold 11 of the first fold. Respective connection folds are disposed between the two inside folds 11, 12 and their connections formed by the tear seam regions 6 extend outwards. These tear seam regions 6 can also be understood as inside folds introduced into the connection folds.

The laying-in of the inside folds in the two steps can take place, for example, in that the bag is slightly inflated and then, in the first step, two fold blades are inserted in the direction of the arrow A to pull out the inside folds 11 and 12 and then, in a second step, another two fold blades are inserted in the direction of the arrow B to pull out the inside folds 15, 16.

The fold is designed in the manner visible from FIG. 3 such that the inside fold edges of the inside folds 15, 16 of the right hand side also project over the line of symmetry 9 and the folds of the sack made in two planes lie on top of one another.

In two further steps, the folded bag parts lying on top of one another in two planes are rolled in the manner visible from FIGS. 4 and 5 in the direction of the bag centre or in the direction of the inflator 5, with the rolls 19, 20 formed thereby being tilted forwards in the direction of the arrows 21, 22 so that the bag folded, rolled and tilted in the manner described is held securely in a frame 23 in whose centre the mouth of the inflator 5 is disposed.

In the embodiment in accordance with FIG. 6, the side parts of the bag are folded in zig-zag manner in the direction of the inflator.

In the embodiment in accordance with FIG. 7, the two layers of the bag are put together by a plurality of inside folds 24, 25 and 26, 27 directed against one another such that the front layer put together by the inside folds 24, 25 is disposed on the lower layer put together by the inside folds 26, 27.

The bag provided with a tear seam region 6 can be inflated by a two-stage inflator, with inflation taking place in the first stage in the manner visible from FIG. 8, in which the tear seam regions 6 have not yet been torn open.

In FIG. 5, the airbag 1 fully inflated in the second stage can be seen in which the tear seam regions 6 have been torn open up to the seams 4.

1. An inflatable airbag (1) for the protection of a vehicle occupant, consisting of a front layer (2) and a rear layer (3) of flexible, tear-resistant material which are connected and folded and/or rolled together along a common peripheral edge (4), with the rear layer (3) facing away from the vehicle occupant being connected to an inflator (5) by a central opening,
characterized in that
the halves or parts of the flat-lying bag disposed on both sides of a line of symmetry (9) are folded by at least two inside folds (11, 12; 15, 16) which are disposed between the layers (2, 3) and whose fold edges (13, 14) extend beyond the line of symmetry (9) and which enclose a connection fold between them, said connection fold having an outwardly directed seam (6) or an outwardly directed seam (4); and
the halves disposed on the line of symmetry (9) are folded or rolled in the direction of the bag centre.

2. An airbag in accordance with claim 1, wherein each side part of the bag is folded by two inside folds (11, 12; 15, 16) lying on top of one another.

3. An airbag in accordance with claim 1, wherein the connection fold is provided with another inside fold.

4. An airbag in accordance with claim 3, wherein the layers of the further inside fold are connected by an adhesive to form a tear seam region (6).

5. An air bag in accordance with any of claims 1 to 4, wherein the sides of the bag (1) disposed on both sides of the line of symmetry (9) are folded in overlapping planes such that the sides provided with the inside folds overlap in a manner lying on top of one another.

6. An air bag in accordance with any of claims 1 to 5, wherein the rolled or folded bag halves disposed on the line of symmetry are tilted forwards in the direction of the vehicle occupant to be protected.

7. An air back in accordance with any of claims to 6, wherein the flat-lying bag has a rectangular or square shape.

8. An inflatable bag in accordance with the preamble of claim 1, characterized in that the halves of the flat-lying bag disposed on both sides of a line of symmetry are folded in a zig-zag manner towards the centre of the bag.

9. An inflatable air bag in accordance with the preamble of claim 1, characterized in that the two layers of the bag are put together by a plurality of inside folds directed against one another such that the front layer put together by inside folds (24, 25) lies on the lower layer put together by inside folds (26, 27).
